(19) United States
(12) Patent Application Publication
(10) Pub. No.: US 2017/0072456 A1
(43) Pub. Date: Mar. 16, 2017

(54) METHOD FOR MAKING BICYCLE FOLDING TOOLS

(71) Applicant: Tuo-Jen Chen, Taichung City (TW)

(72) Inventor: Tuo-Jen Chen, Taichung City (TW)

(21) Appl. No.: 14/854,048

(22) Filed: Sep. 15, 2015

(51) Int. Cl. B21K 5/16; B25B 15/00

(52) U.S. Cl. CPC B21K 5/16; B25B 15/001

(57) ABSTRACT

A method for making folding bicycle tools is disclosed. A semi-finished product is a bar and each distance between two opposite sides of the bar is equal and has two using ends and a working section arranged therebetween. Two transferring sections are respectively arranged between each using end and the working end. A distance Z1 between two sides of the transferring section is less than a distance Y1 between two sides of the working section. Two side surfaces of the working section is flatted to become a flatted surface respectively. Y1 is less than or equal to double of a height X of the working section after being flatted and Z1 is less than or equal to X. The working section is cut to form two finished products and each has an assembling end which provides the an assembling hole to pass through and formed on the corresponding flatted surface.

### BACKGROUND OF THE INVENTION

1. Field of the Invention

The present invention relates to a method for making bicycle folding tools, and especially relates to a method for working a head of the folding tool.

2. Description of Related Art

The conventional wrench is formed by working a using end of a bar and then bending it. The cross-section of the bar is circle or each of two opposite sides of the cross-section of the bar has same distance. It may be low cost and mass production due to the formation of the using end of the wrench and coaxial turning and milling molding. However, the length of the raw materials needs to be adapted for using the wrench, and further reserve a predetermined length for bending an assembling end (L section shown as in FIG. 1). Therefore, the cost of the raw materials is still high, the volume of the assembling end is high, and the wrench is inconvenient to carry.

Please reference to Taiwanese patent no. M299063, D117670, D132239, M336113, and etc. or FIG. 2. FIG. 2 is a perspective view of a second embodiment of a conventional tool for improving the flatness and light weight. However, the using end of the extrusion bar is turned and milled and then bored/milled to form an assembling hole at a rear end. Although the quantity of materials may be decreased to reduce cost effectively, it must use the bar with a rectangular cross-section (dash line in FIG. 2) to fit in with the flatness and prevent the volume and weight of the assembling end from oversizing. Therefore, when working and forming the using end, there may have disadvantages which are described as follows due to the different distances of two opposite sides of the cross-section of the bar and the great differences between the preforming size of the wrench and the volume of the bar.

Firstly, two sides may be recut or not cut while coaxially cutting, and the blade is east to be damaged while working. In order to avoid above mentioned situations, the feed rate must be decreased and the working period and time must be increased (shown as in FIG. 3).

Secondly, single-side cutting will result in press unevenly and the structure of the folding tool may be easy to be broken.

Thirdly, the assembly with interference may make users inconvenient while using. For example, when taking the short-end tool, the long-end tool must be removed first.

In conclusion, the cost and defect rate are still high.

Please also reference to Taiwanese patent no. 1383868 and FIG. 4 for a conventional folding tool with light weight. It points out that the terminal end of the tool reduces too much volume in order to effectively lighten weight. The conventional extrusion wiring structure has insufficient supporting force, especially the thickness of the terminal end of the small size folding tool is thicker and the situations is more obvious. Therefore, the plastic deformation process is developed to improve the structure density. Besides the problem of the high volume of the assembling end is solved, the rigidity of the structure may be still kept. However, the cylindrical steel material must be molded by drop forging again to result in concentrating stress and hardening. Therefore, it must be softened by annealing so as to flatten and mill the assembling end to form the wanted thickness and final size.

Although the processes of drop forging and flattening may shrink volume and get better hardness of structure, the carbon elimination may be generated while annealing in order to eliminate the working stress which is remained from the process of drop forging. The strength of the material may be not enough after heating for hardening, especially for the folding tool with smaller size. The process of drop forging takes too long time and then makes the cost much higher. It is not practical and popular.

In addition, please reference to Taiwanese patent no. 1369274, it disclosed a making method which adds a process of flatting a bending end and a process of removing surplus materials before the conventional bending process to overcome the disadvantages of high cost and long process of the U.S. Pat. No. 1,383,868. Although the process of plastic deformation by flatting may effectively improve the structure density of the bar and the assembling end so as to improve hardness, the bending end may be hardened while working due to the redundant stress after flatting, shown as in FIG. 5. In the bending process, the bar is easy to be broken or may not be bent and further the stability in production may be influenced. And the service life of the mold may be shortened.

Furthermore, the turning end of the wrench formed by the bending process may be formed a notch and the opened notch may not take the torque force, show as in FIG. 6 (similar to FIG. 1). When considering the strength of the structure, the above mentioned process may not reduce the volume of the assembling end. And he cost is still high.

In accordance with above mentioned conventional methods or skills, a folding tool making method with following characteristics may be generalized to be developed.

Firstly, the bar materials need to have same distance in each two opposite sides or circle cross-section so as to save working time and reduce cost.

Secondly, it should effectively increase the density of the materials and improve the hardness of the structure through a suitable plastic deformation process, but the plastic deformation process with large amount of deformation may be not arranged after the aforementioned suitable plastic deformation process to make working more difficult and defect rate much higher.

Thirdly, in order to avoid the assembling end to become a notch, a closed assembling end may effectively reduce the volume of the tool (wrench) and improve the hardness of the structure.

Fourthly, the assembling end should avoid to use the conventional bending process to effectively reduce the volume and weight of the tool and further reduce the material cost.

Fifthly, the folding tool should avoid to use annealing process to prevent the carbon elimination which is generated from the surface of the tool to result in material hardening after the heating process and then the mechanical properties and strength may not do what they are good at.

In view of the foregoing circumstances, the inventor has invested a lot of time to study the relevant knowledge, compare the pros and cons, research and develop related products. After quite many experiments and tests, the “folding tool making method” of this invention is eventually launched to improve the foregoing shortcomings, to meet the public use.

### SUMMARY OF THE INVENTION

In order to solve above mentioned problems, this invention is providing a method for making bicycle folding tools. The folding tools are the flathead folding wrenches. The steps of the making method comprising preparing a semi-finished product, flatting plastic working, and forming an assembling hole; wherein:

the step of preparing the semi-finished product: the semi-finished product is a bar and each distance between two opposite sides of the bar is equal, the semi-finished product has two using ends and a working section, two ends of the working section are respectively connected with the two using ends, two transferring sections are further respectively arranged between each using end and the working end, a distance between two opposite sides of the transferring section is Z1, a distance between two opposite sides of the working section is Y1, and Z1 is less than Y1 to form a raw material;

the step of flatting plastic working: two opposite side surfaces of the working section is flatted to become a flatted surface respectively, a height of the working section after being flatted is X, and Y1 is less than or equal to 2X and Z1 is less than or equal to X; and

the step of forming the assembling hole: the working section is cut to form two finished products, each of the two finished products has an assembling end, the assembling hole is passing through the corresponding assembling end and formed on the corresponding flatted surface.

In some embodiments, the step of forming the assembling hole further includes a step of removing surplus materials, the surplus materials formed at a rear end of each assembling end are removed by die cutting.

In some embodiments, the step of flatting plastic working further includes a step of removing surplus materials, the surplus materials formed at a rear end of each assembling end are removed by die cutting, and simultaneously each side of the working section is flatted.

In order to solve above mentioned problems, this invention is further providing a method for making bicycle folding tools, the folding tools exclude the flathead folding wrench, the steps of the making method comprising preparing a semi-finished product, flatting plastic working, and forming an assembling hole; wherein:

the step of preparing the semi-finished product: the semi-finished product is a bar and each distance between two opposite sides of the bar is equal, the semi-finished product has two using ends and a working section, two ends of the working section are respectively connected with the two using ends, two transferring sections are further respectively arranged between each using end and the working end, a distance between two opposite sides of each using end is Z2, a distance between two opposite sides of the working section is Y, and Z2 is less than Y to form a raw material;

the step of flatting plastic working: two opposite side surfaces of the working section is flatted to become a flatted surface respectively, a height of the working section after being flatted is X2, and Y is less than or equal to 2X2 and Z1 is less than or equal to X2; and

the step of forming the assembling hole: the working section is cut to form two finished products, each of the two finished products has an assembling end, the assembling hole is passing through the corresponding assembling end and formed on the corresponding flatted surface.

In some embodiments, the step of forming the assembling hole further includes a step of removing surplus materials, the surplus materials formed at a rear end of each assembling end are removed by die cutting.

In some embodiments, the step of flatting plastic working further includes a step of removing surplus materials, the surplus materials formed at a rear end of each assembling end are removed by die cutting, and simultaneously each side of the working section is flatted.

The various objectives and advantages of the present invention will be more readily understood from the following detailed description when read in conjunction with the appended drawing.

### BRIEF DESCRIPTION OF THE DRAWINGS

FIG. 1 is a structural view of a conventional folding tool making method of a first embodiment of a conventional tool;

FIG. 2 is a perspective view of a second embodiment of a conventional tool;

FIG. 3 is a view of a third embodiment of a conventional tool while defectively forming the materials which have two sides with different lengths;

FIG. 4 is a perspective view of a fourth embodiment of a conventional tool;

FIG. 5 is a view of a conventional tool which is work hardening while cutting;

FIG. 6 is a view of a conventional tool without the holding capacity of structure while forming a notch;

FIG. 7 is a flow chart of a first embodiment of a method for making a flathead folding wrench of the present invention;

FIG. 8 is a perspective view of a first step for making the flathead folding wrench of the present invention;

FIG. 9 is an appearance drawing of the first step for making the flathead folding wrench of the present invention;

FIG. 10 is an appearance drawing of a second step for making the flathead folding wrench of the present invention;

FIG. 11 is a structural view of an assembling hole of a third step for making the flathead folding wrench of the present invention;

FIG. 12 is a perspective view of a second embodiment of a method for making a tool which excludes the flathead folding wrench;

FIG. 13 is an appearance drawing of the first step of the second embodiment of the present invention;

FIG. 14 is an appearance drawing of a second step of the second embodiment of the present invention;

FIG. 15 is a structural view of an assembling hole of a third step of the second embodiment of the present invention;

FIG. 16 is a flow chart of the second step of flatting plastic working and a step of removing surplus materials;

FIG. 17 is a flow chart of the step of removing surplus materials and the third step of forming the assembling hole;

FIG. 18 is a perspective view of the step of removing surplus materials and the third step of forming the assembling hole; and

FIG. 19 is a perspective view of the second step of flatting plastic working and a step of removing surplus materials.

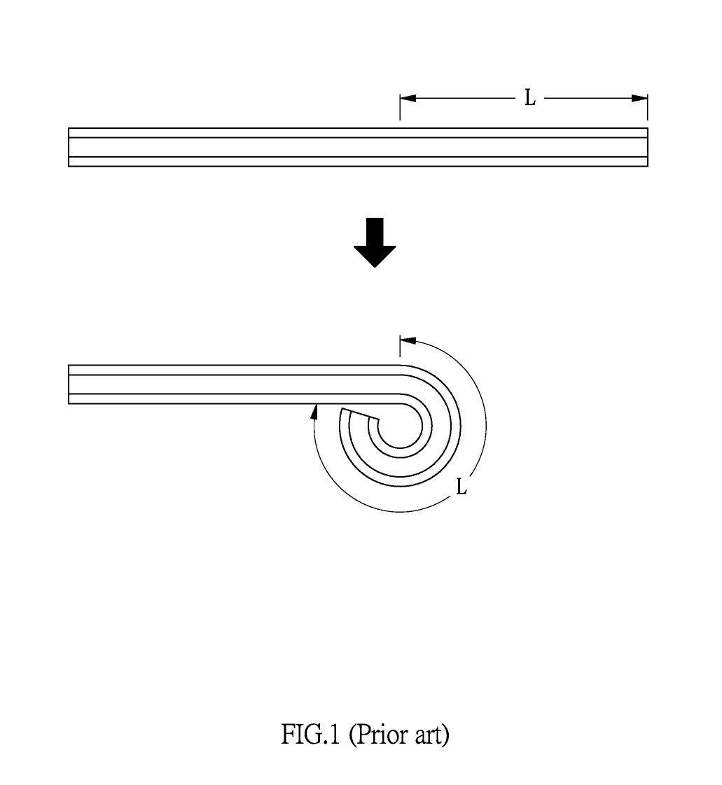

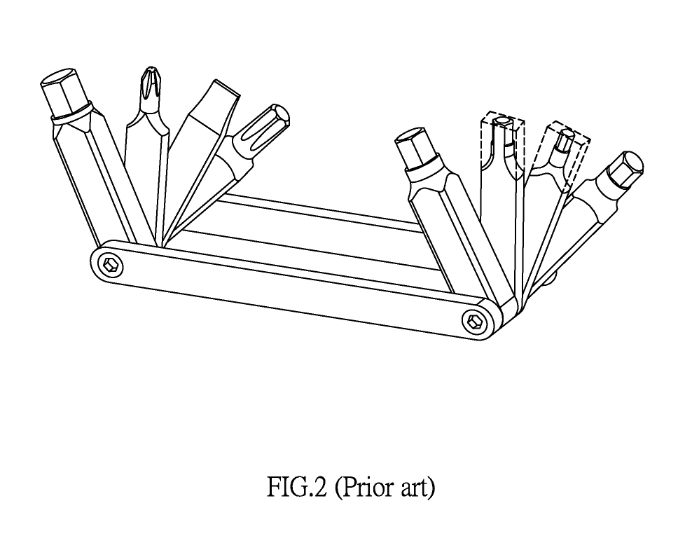

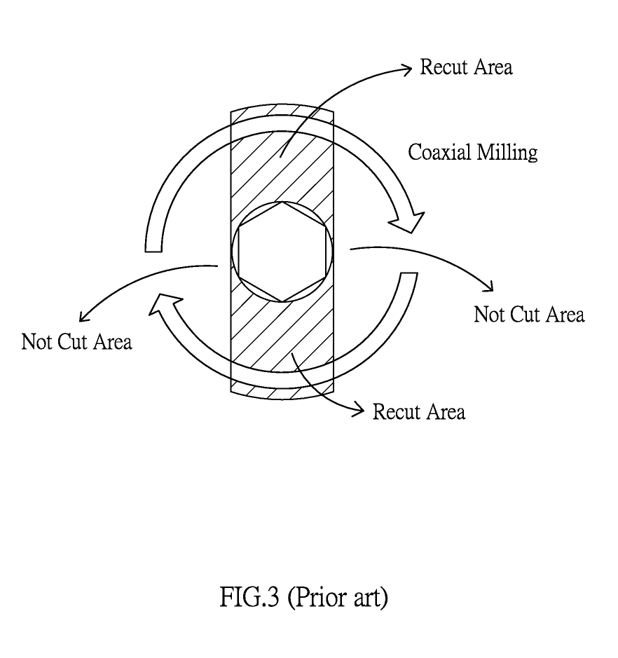

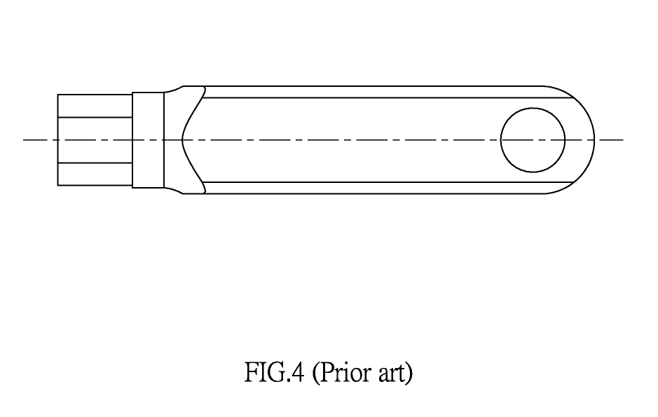

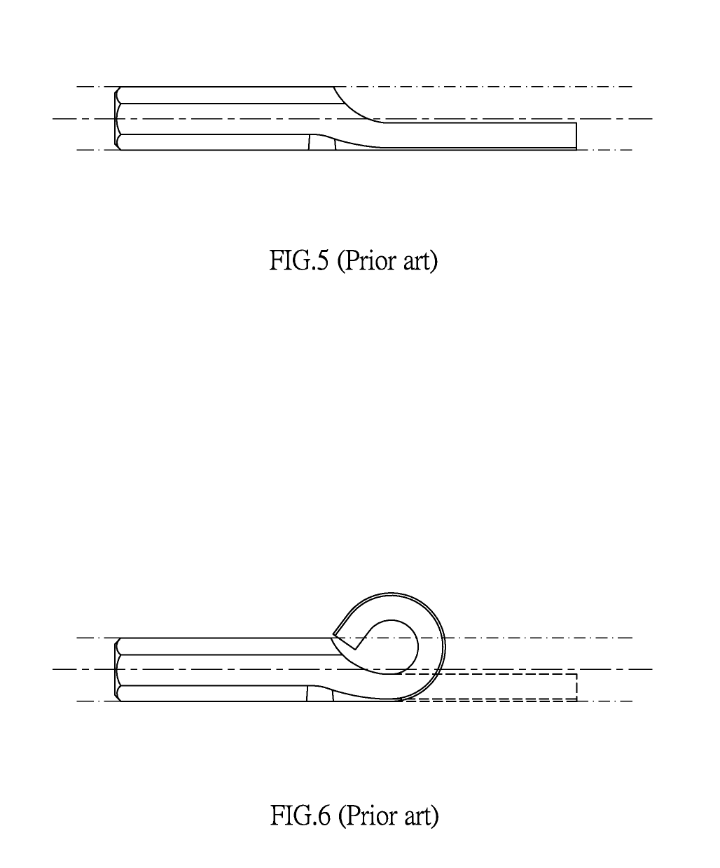

### DETAILED DESCRIPTION OF THE INVENTION

To describe clearly that the present invention achieves the foregoing objective and function, the technical features and desired function are described with reference to a preferred embodiment and accompanying drawings.

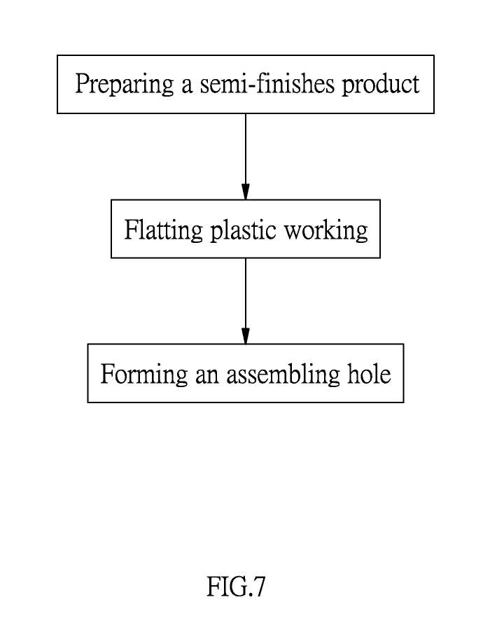

Please reference to FIG. 7, it is a flow chart of a first embodiment of a method for making a flathead folding wrench of the present invention. The steps of the method of making bicycle folding tools of present invention may comprise preparing a semi-finished product (the first step), flatting plastic working (the second step), and forming an assembling hole (the third step).

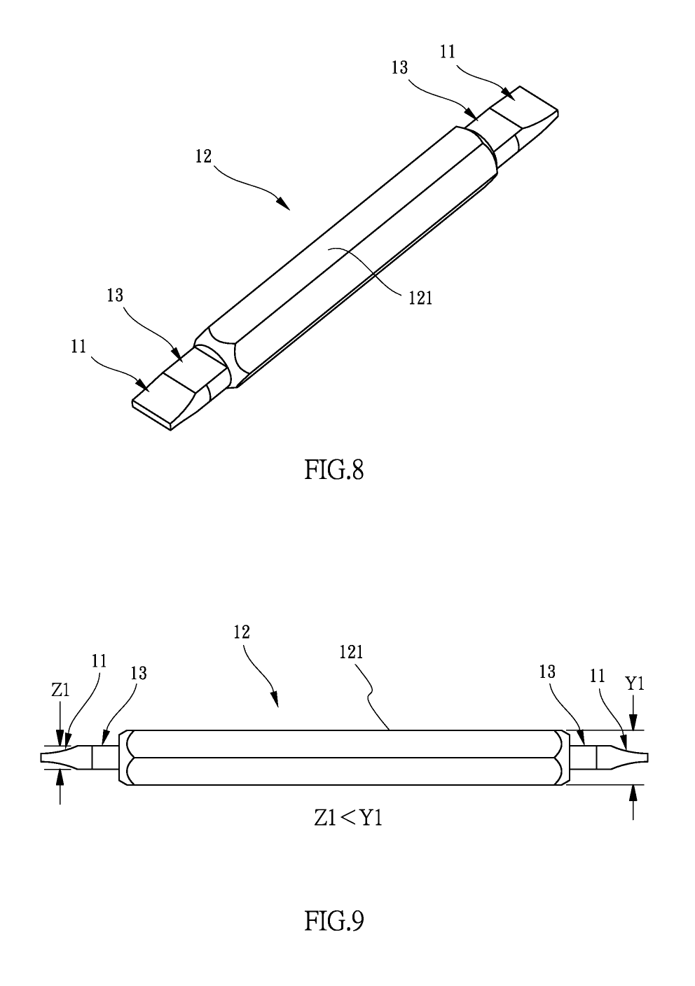

For the first step, please refer to FIGS. 8 and 9. The semi-finished product is a bar with a hexagonal, square, or circle cross-section (they have the characteristics that each distance between two opposite sides of the bar is equal). The semi-finished product has two using ends 11 and a working section 12. Two ends of the working section 12 are respectively connected with the two using ends 11. Two transferring sections 13 are further respectively arranged between each using end 11 and the working end 12. A distance between two opposite sides of the transferring section 13 is Z1. A distance between two opposite sides of the working section 12 is Y1. And Z1 is less than Y1 to form a raw material so that the working section 12 may be formed while processing next step (the second step).

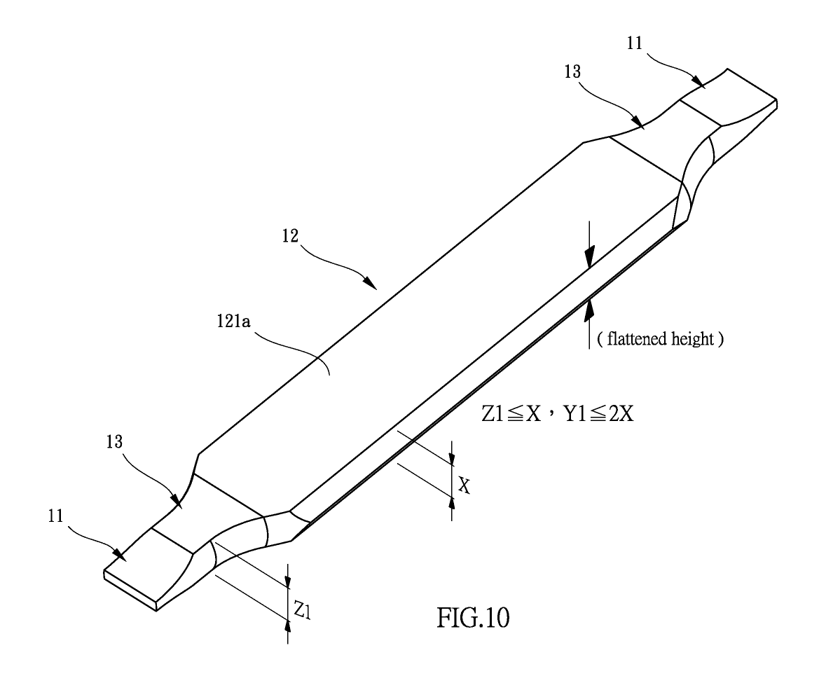

For the second step, two opposite side surfaces of the working section 12 is flatted to become a flatted surface 121a respectively. A height of the working section 12 after being flatted is X. And Y1 is less than or equal to 2X. Therefore, the second step may be processed without annealing in advance so that the working section 12 may have firm structure. When Z1 is less than or equal to X after flatting plastic working (shown as in FIG. 10), each wrench after assembling may be not influenced while rotating and provide useful thickness and strength of structure of the working section 12 relative to the corresponding using end 11 for pulling.

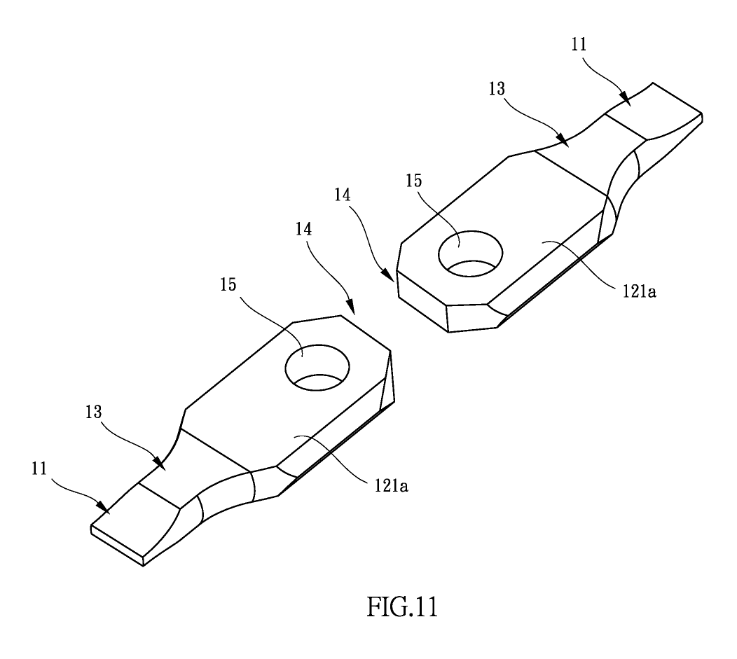

For the third step, the working section 12 is cut to form two finished products. Each of the two finished products has an assembling end 14. The assembling hole 15 is passing through the corresponding assembling end 14 and formed on the corresponding flatted surface 121a (shown as in FIG. 11).

In accordance with above mentioned making method, the wrench may have longer service life and the effects of working quickly and reducing manufacturing cost and time while forming each using end 11 since the semi-finished product is a bar that each distance between two opposite sides of the bar is equal and the cross-section of the bar is coaxial and capable for mass production. In addition, the using ends 1 may be also formed by head hitting with a specific mold whose each of two opposite sides has same distance (such as hex key wrench or TORX key wrench). Besides the bar whose each of two opposite sides has same distance or whose cross-section is circle is easy to cooperate with other materials, using large quantities, and easy to be obtained, the cost is further cheaper to effectively reduce cost due to making prices with quantity. The design of the distance Y1 and the distance X makes Y1 be less than or equal to 2X. It may not only improve the strength of structure of the working section 12 and the cutting process after shrinking the volume of the bar, but also the materials may be further saved and then reduce cost comparing to the conventional skill. The limitation of the Z1 and X may make the thickness of the assembling end 14 be not larger than the height of the using ends 11 while the wrench is rotating after finishing assembling. They may not influenced each other and provide the useful thickness and strength for pulling. The storage space for laterally assembling may be maximized so as to save space and carry with convenience. In conclusion, the tool which is made by the making method of present invention may effectively reduce cost, carrying space, and weight to achieve the effects of present invention.

Furthermore, the steps of the method for making bicycle folding tools that the tools exclude a flathead folding wrench comprise preparing a semi-finished product (the first step), flatting plastic working (the second step), and forming an assembling hole (the third step).

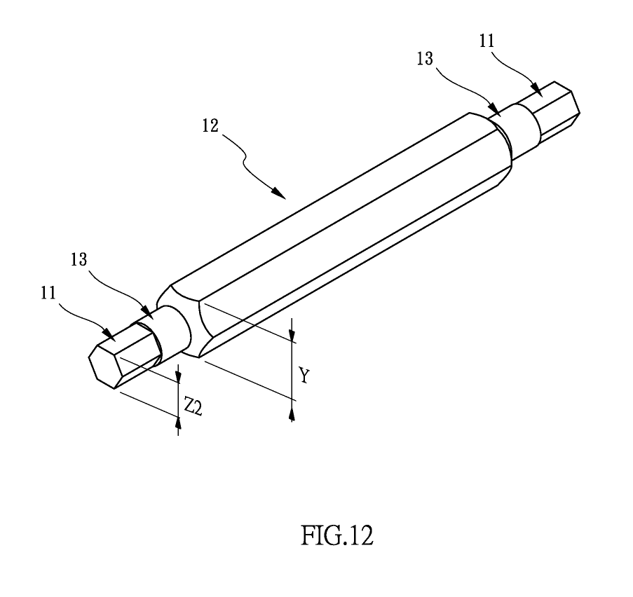

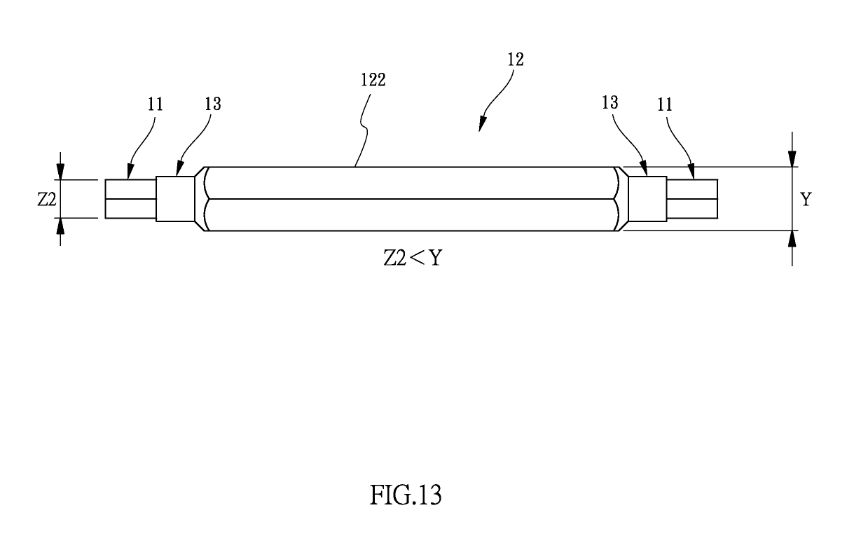

For the first step, please refer to FIGS. 12 and 13. The semi-finished product is a bar with a hexagonal, square, or circle cross-section (they have the characteristics that each distance between two opposite sides of the bar is equal, and the distance between two opposite sides of the circle cross-section is the diameter of the circle). The semi-finished product has two using ends 11 and a working section 12. Two ends of the working section 12 are respectively connected with the two using ends 11. Two transferring sections 13 are further respectively arranged between each using end 11 and the working end 12. A distance between two opposite sides of each using end 11 is Z2. A distance between two opposite sides of the working section 12 is Y. And Z2 is less than Y to form a raw material so that the working section 12 may be formed while processing next step (the second step).

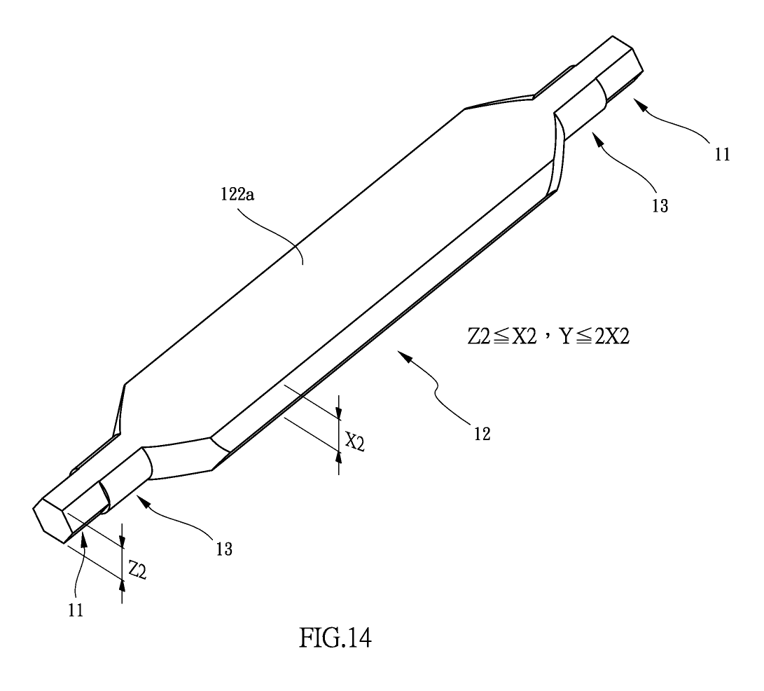

For the second step, two opposite side surfaces of the working section 12 is flatted to become a flatted surface 121a respectively. A height of the working section 12 after being flatted is X. And Y is less than or equal to 2X. Therefore, the second step may be processed without annealing in advance so that the working section 12 may have firm structure. When Z2 is less than or equal to X after flatting plastic working (shown as in FIG. 14), each wrench after assembling may be not influenced while rotating and provide useful thickness and strength of structure of the working section 12 relative to the corresponding using end 11 for pulling.

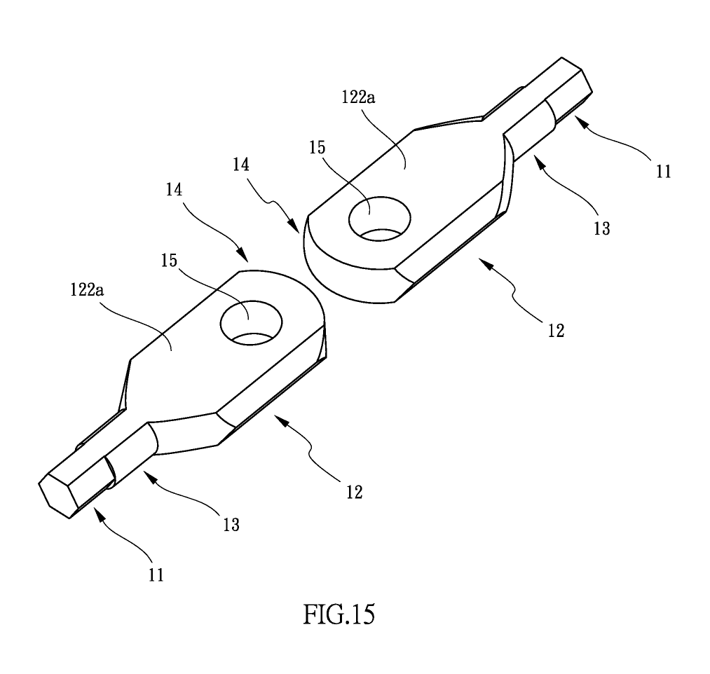

For the third step, the working section 12 is cut to form two finished products. Each of the two finished products has an assembling end 14. The assembling hole 15 is passing through the corresponding assembling end 14 and formed on the corresponding flatted surface 121a (shown as in FIG. 15).

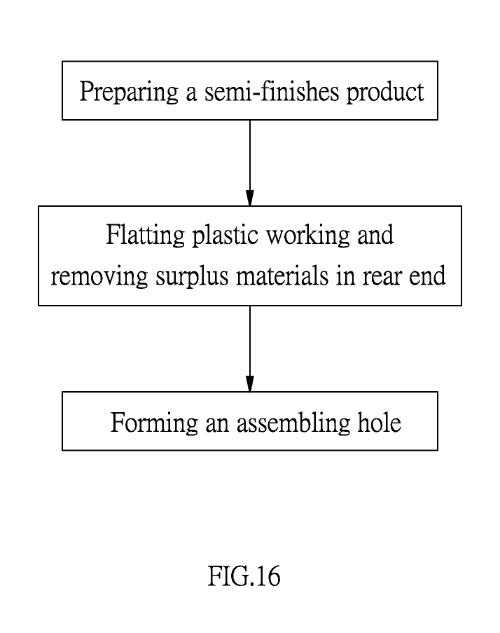

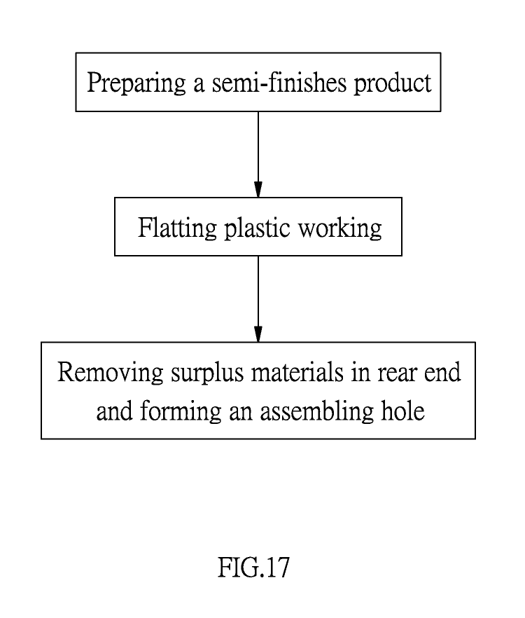

The above mentioned two kinds of embodiments of the step of forming the assembling hole further include a step of removing surplus materials (the fourth step). The fourth step may be processed with the third step or the second step, shown as in FIGS. 16 and 17.

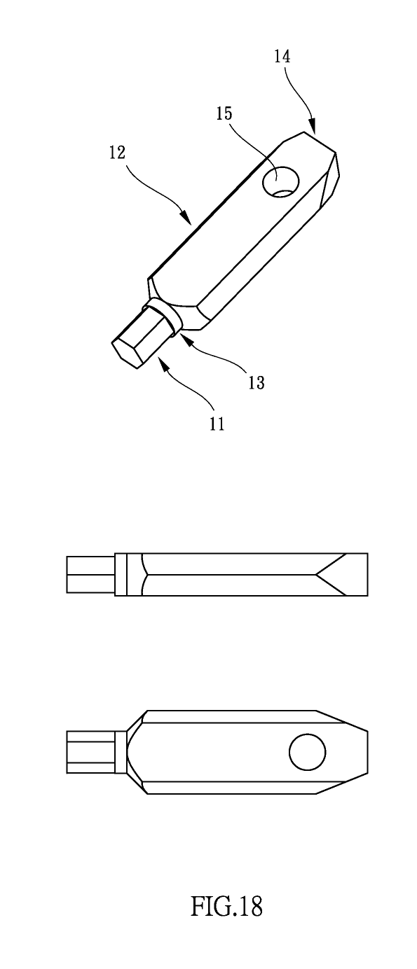

When the step of removing surplus materials (the fourth step) is processed with the step of forming the assembling hole 15 (the third step), the surplus materials which are formed at a rear end of each assembling end 14 is removed by die cutting and simultaneously each assembling hole 15 is formed at the assembling end 14 (shown as in FIG. 18).

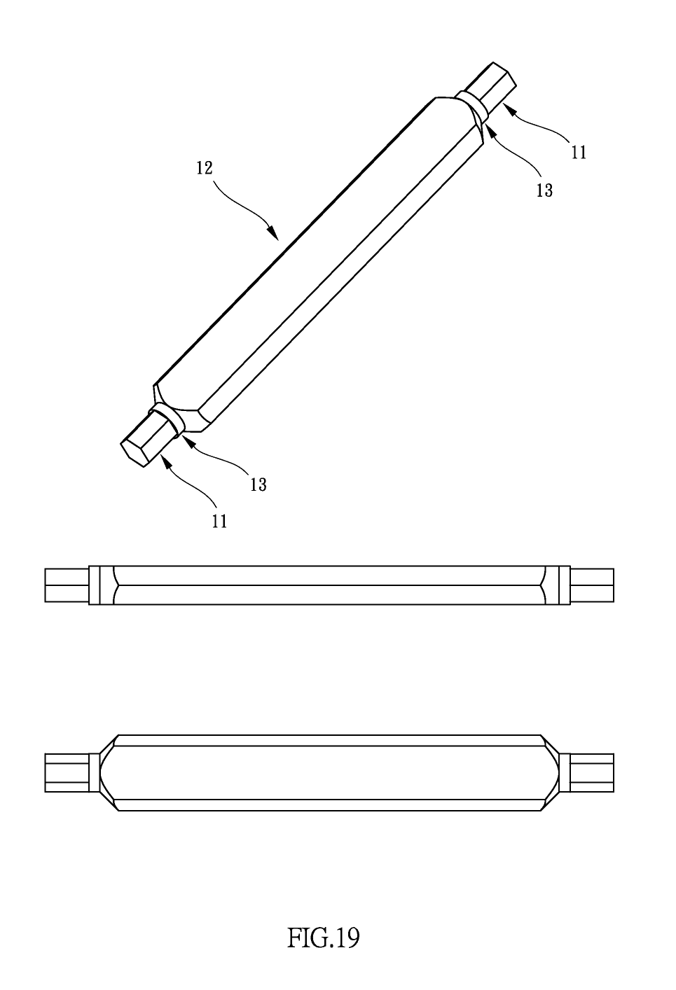

When the step of removing surplus materials (the fourth step) is processed with the step of flatting plastic working (the second step), the redundant surplus materials which are formed at the rear end of each assembling end 14 is removed by die cutting and simultaneously the sides of the working section 12 is processed to flat (shown as in FIG. 19).

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A method for making folding bicycle tools, the folding tools are flathead folding wrenches, the steps of the making method comprising preparing a semi-finished product, flatting plastic working, and forming an assembling hole; wherein:
the step of preparing the semi-finished product: the semi-finished product is a bar and each distance between two opposite sides of the bar is equal, the semi-finished product has two using ends and a working section, two ends of the working section are respectively connected with the two using ends, two transferring sections are further respectively arranged between each using end and the working end, a distance between two opposite sides of the transferring section is Z1, a distance between two opposite sides of the working section is Y1, and Z1 is less than Y1 to form a raw material;
the step of flatting plastic working: two opposite side surfaces of the working section is flatted to become a flatted surface respectively, a height of the working section after being flatted is X, and Y1 is less than or equal to 2X and Z1 is less than or equal to X; and
the step of forming the assembling hole: the working section is cut to form two finished products, each of the two finished products has an assembling end, the assembling hole is passing through the corresponding assembling end and formed on the corresponding flatted surface.

2. The method as claimed in claim 1, wherein the step of forming the assembling hole further includes a step of removing surplus materials, the surplus materials formed at a rear end of each assembling end are removed by die cutting.

3. The method as claimed in claim 1, wherein the step of flatting plastic working further includes a step of removing surplus materials, the surplus materials formed at a rear end of each assembling end are removed by die cutting, and simultaneously each side of the working section is flatted.

4. A method for making folding bicycle tools, the folding tools exclude flathead folding wrenches, the steps of the making method comprising preparing a semi-finished product, flatting plastic working, and forming an assembling hole; wherein:
the step of preparing the semi-finished product: the semi-finished product is a bar and each distance between two opposite sides of the bar is equal, the semi-finished product has two using ends and a working section, two ends of the working section are respectively connected with the two using ends, two transferring sections are further respectively arranged between each using end and the working end, a distance between two opposite sides of each using end is Z2, a distance between two opposite sides of the working section is Y, and Z2 is less than Y to form a raw material;
the step of flatting plastic working: two opposite side surfaces of the working section is flatted to become a flatted surface respectively, a height of the working section after being flatted is X2, and Y is less than or equal to 2X2 and Z1 is less than or equal to X2; and
the step of forming the assembling hole: the working section is cut to form two finished products, each of the two finished products has an assembling end, the assembling hole is passing through the corresponding assembling end and formed on the corresponding flatted surface.

5. The method as claimed in claim 4, wherein the step of forming the assembling hole further includes a step of removing surplus materials, the surplus materials formed at a rear end of each assembling end are removed by die cutting.

6. The method as claimed in claim 4, wherein the step of flatting plastic working further includes a step of removing surplus materials, the surplus materials formed at a rear end of each assembling end are removed by die cutting, and simultaneously each side of the working section is flatted.
